(19) United States
(12) Patent Application Publication
(10) Pub. No.: US 2016/0267453 A1
(43) Pub. Date: Sep. 15, 2016

(54) SERVICE PROVIDING SYSTEM, SERVER DEVICE, AND SERVICE PROVIDING METHOD

(71) Applicant: Toshiya SUZUKI, Kanagawa (JP)

(72) Inventor: Toshiya SUZUKI, Kanagawa (JP)

(73) Assignee: RICOH COMPANY, LTD., Tokyo (JP)

(21) Appl. No.: 15/008,687

(22) Filed: Jan. 28, 2016

(30) Foreign Application Priority Data
Mar. 12, 2015 (JP) 2015-049942

(51) Int. Cl. G06Q 20/14; H04W 4/00; H04W 84/04; H04L 29/12; H04W 8/20; H04J 11/00

(52) U.S. Cl. CPC G06Q 20/145; H04W 8/205; H04J 11/0069; H04W 84/047; H04L 61/1547; H04W 4/008; H04W 88/02

(57) ABSTRACT

A service providing system includes a terminal; a repeater; and a server device. The terminal includes a terminal short range radio communication unit configured to perform short range radio communication with the repeater, and a terminal transmitting unit configured to send a connection request including a user ID for identifying a user of the terminal, to the server device. The server device includes a receiving unit configured to receive a connection request including a repeater ID for identifying the repeater and the user ID, from the terminal or the repeater, and a service management unit configured to manage a type of a service that can be provided to the user, based on the received repeater ID and user ID.

### BACKGROUND OF THE INVENTION

1. Field of the Invention

The present invention relates to a service providing system, a server device, and a service providing method.

2. Description of the Related Art

When attending a class (a lecture) at a cram school, a university, etc., the attendance fee is generally uniformly charged. Furthermore, when purchasing an additional study material, etc., it is generally necessary to register in advance.

Patent Document 1 discloses a system in which the learner and the learning supporter register conditions, and when both conditions are satisfied, information for learning is provided.

However, Patent Document 1 does not disclose a technology of providing a service and charging a fee for a service according to the position of the seat, etc., in a class, etc., that the user has attended.

Patent Document 1: Japanese Laid-Open Patent Publication No. 2002-318859

### SUMMARY OF THE INVENTION

The present invention provides a service providing system, a server device, and a service providing method, in which one or more of the above-described disadvantages are eliminated.

According to an aspect of the present invention, there is provided a service providing system including a terminal; a repeater; and a server device, wherein the terminal includes a terminal short range radio communication unit configured to perform short range radio communication with the repeater, and a terminal transmitting unit configured to send a connection request including a user ID for identifying a user of the terminal, to the server device, and wherein the server device includes a receiving unit configured to receive a connection request including a repeater ID for identifying the repeater and the user ID, from the terminal or the repeater, and a service management unit configured to manage a type of a service that can be provided to the user, based on the received repeater ID and user ID.

According to an aspect of the present invention, there is provided a server device including a receiving unit configured to receive a connection request, the connection request including a user ID for identifying a user of a terminal and a repeater ID that is information for identifying a repeater that performs short range radio communication with the terminal; and a service management unit configured to manage a type of a service that can be provided to the user, based on the received repeater ID and user ID.

According to an aspect of the present invention, there is provided a service providing method executed by a server device, the service providing method including receiving a connection request, the connection request including a user ID for identifying a user of a terminal and a repeater ID that is information for identifying a repeater that performs short range radio communication with the terminal; and managing a type of a service that can be provided to the user, based on the received repeater ID and user ID.

### BRIEF DESCRIPTION OF THE DRAWINGS

Other objects, features and advantages of the present invention will become more apparent from the following detailed description when read in conjunction with the accompanying drawings, in which:

FIG. 1 is a conceptual diagram of a service providing system according to a first embodiment;

FIG. 2 is a configuration diagram of the service providing system according to the first embodiment;

FIG. 3 illustrates an example of class information;

FIG. 4 illustrates an example of room/repeater information;

FIG. 5 illustrates an example of service information;

FIG. 6 illustrates an example of class attendance history;

FIG. 7 illustrates an example of charging information;

FIG. 8 illustrates an example of contents information;

FIG. 9 is a sequence diagram of the service providing system according to the first embodiment;

FIG. 10 is a flowchart of a service authentication process;

FIG. 11 is a sequence diagram of a process of reporting charging information;

FIG. 12 is a configuration diagram of the service providing system according to a second embodiment;

FIG. 13 illustrates an example of connection history information;

FIG. 14 is a configuration diagram of the service providing system according to a third embodiment;

FIG. 15 illustrates an example of charging setting information;

FIG. 16 is a hardware configuration diagram of an example of a terminal; and

FIG. 17 is a hardware configuration diagram of an example of a server device.

### DETAILED DESCRIPTION OF THE PREFERRED EMBODIMENTS

### First Embodiment

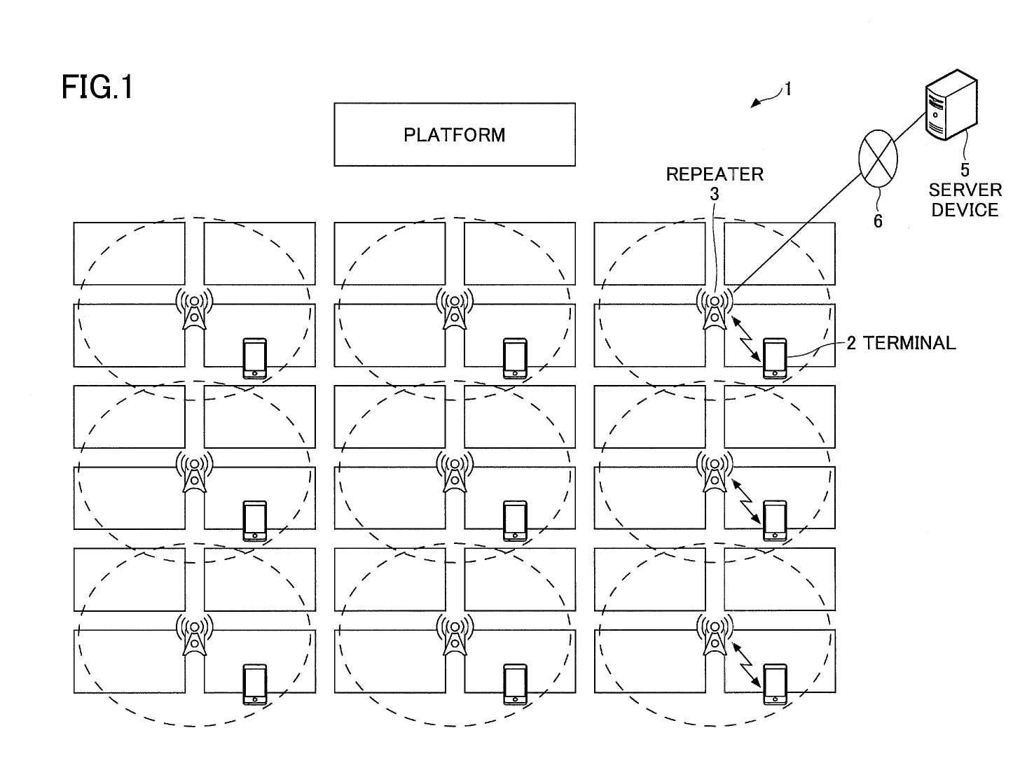

FIG. 1 is a conceptual diagram of a service providing system 1 according to a first embodiment.

The service providing system 1 includes a terminal 2, a repeater 3, and a server device 5. The repeater 3 is provided in, for example, a classroom in which the class (example of “event”) is held. The terminal 2 and the server device 5 are connected by the repeater 3. The repeater 3 and the server device 5 are connected via a transmission network 6 such as a LAN, the Internet, a mobile phone network, etc.

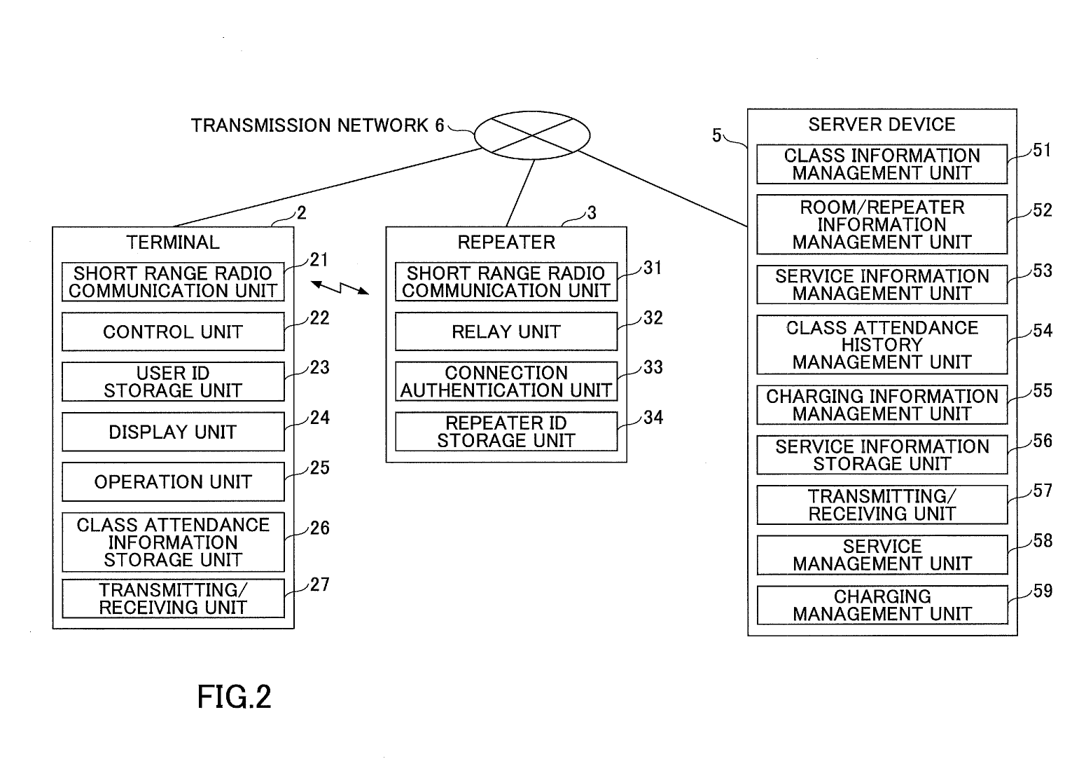

FIG. 2 is a configuration diagram of the service providing system 1 according to the first embodiment.

The terminal 2 is a smartphone, a tablet terminal, a notebook PC, etc., and includes a short range radio communication unit 21, a control unit 22, a user ID storage unit 23, a display unit 24, an operation unit 25, a class attendance information storage unit 26, and a transmitting/receiving unit 27.

The short range radio communication unit 21 performs communication with the repeater 3 by using short range radio lines such as BLE (Bluetooth (registered trademark) Low Energy), NFC (Near Field Communication), wireless LAN, etc.

The control unit 22 performs a process of generating a request to download a content, etc., according to a user's operation input, communication with an external device, etc.

The user ID storage unit 23 stores a user ID, which is information for identifying the user of the terminal 2. The user ID may be information for identifying the terminal of the user, such as a MAC address, a manufacturing number, a telephone number, etc., of the terminal 2.

The display unit 24 displays a screen such as user interface on the terminal 2.

The operation unit 25 receives an operation input from the user.

The class attendance information storage unit 26 stores predetermined information received from the server device 5.

The transmitting/receiving unit 27 performs communication with the server device 5 via the transmission network 6.

The repeater 3 includes a short range radio communication unit 31, a relay unit 32, a connection authentication unit 33, and a repeater ID storage unit 34.

The short range radio communication unit 31 performs communication with the terminal 2, by using short range radio lines such as BLE, NFC, wireless LAN, etc.

The relay unit 32 relays the short range radio communication by the short range radio communication unit 31 and communication performed by using wired lines such as wired LAN, the Internet, etc.

The repeater ID storage unit 34 stores a repeater ID that is an ID of the own device set in advance.

The connection authentication unit 33 authenticates the terminal 2 to be connected. When the radio field intensity of from the terminal 2 is greater than or equal to a predetermined value, the terminal 2 is successfully authenticated. Alternatively, the radio field intensity to be sent from the repeater 3 to the terminal 2 may be set to be weak, and all terminals 2 that can perform communication with the repeater 3 may be successfully authenticated. Furthermore, the authentication may be performed by using a password, etc., received from the terminal 2.

The server device 5 includes a class information management unit 51, a room/repeater information management unit 52, a service information management unit 53, a class attendance history management unit 54, a charging information management unit 55, a service information storage unit 56, a transmitting/receiving unit 57, a service management unit 58, and a charging management unit 59.

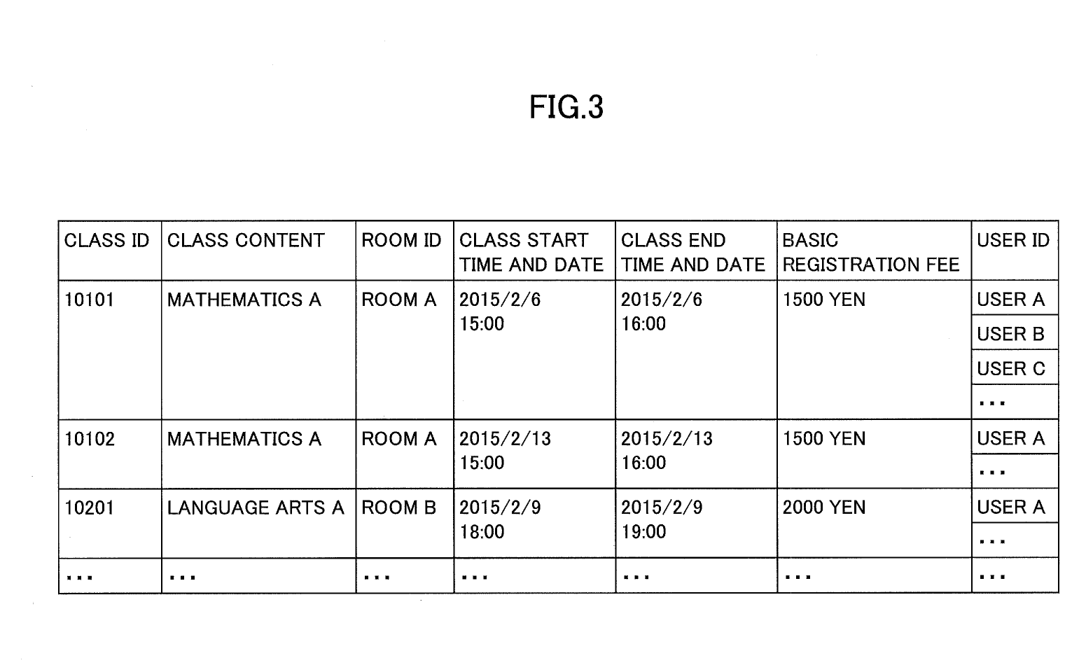

FIG. 3 illustrates an example of class information. The class information management unit 51 manages settings of the class information illustrated in FIG. 3, including a class ID, a class content, a room ID which is the ID of the used room, the class start time and date, the class end time and date, the basic registration fee that arises at the time point of applying for the class without attending the class, and the user ID of the user who applied for the class.

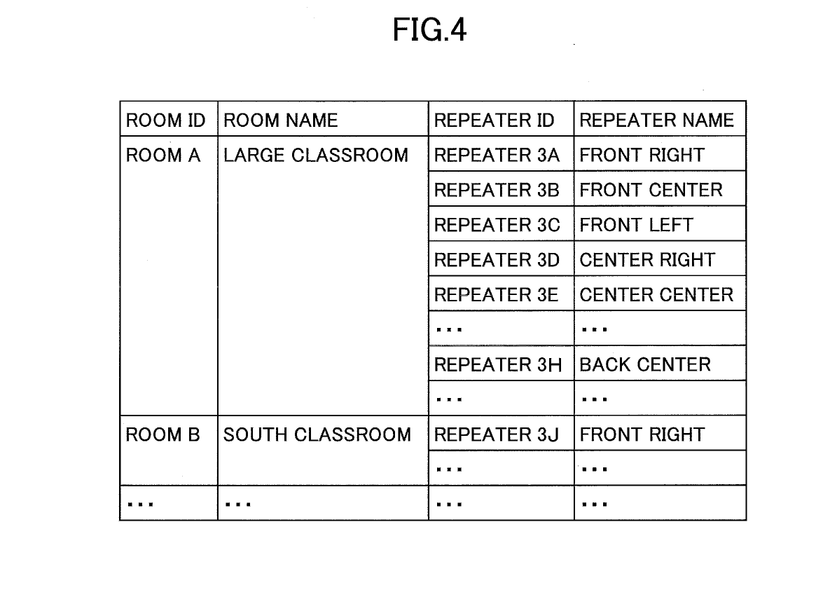

FIG. 4 illustrates an example of room/repeater information. The room/repeater information management unit 52 stores the room/repeater information illustrated in FIG. 4, including a room ID, a room name, a repeater ID, and a repeater name that is the name, etc. of the location where the repeater 3 is disposed.

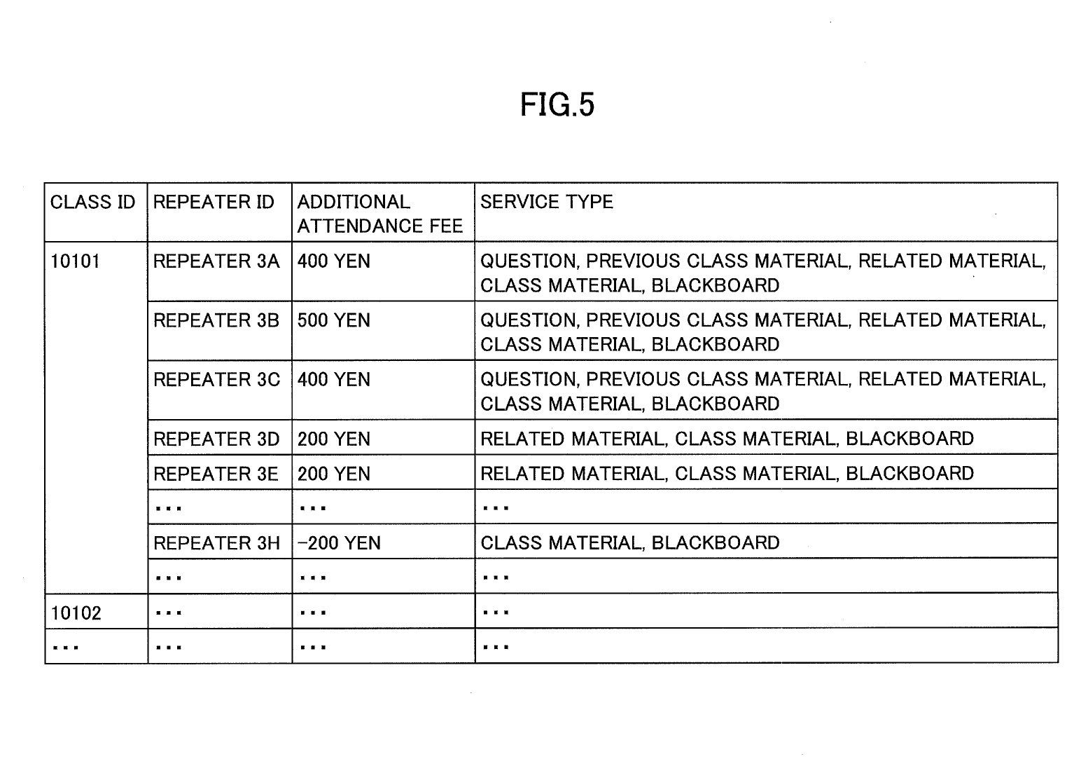

FIG. 5 illustrates an example of service information. The service information management unit 53 manages settings of the service information, including the additional attendance fee that is the fee that arises when attending the class and the type of service that can be provided, for each class ID and each repeater ID.

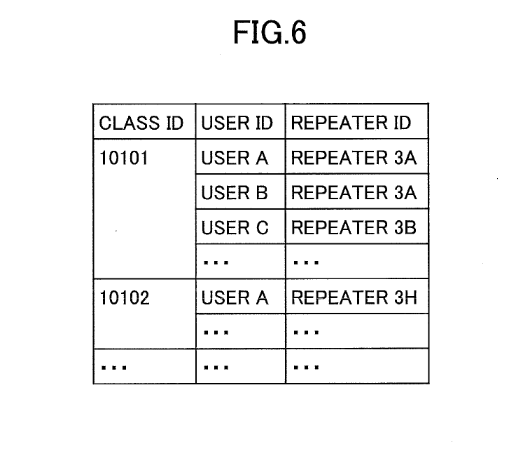

FIG. 6 illustrates an example of class attendance history. The class attendance history management unit 54 stores class IDs, user IDs, and repeater IDs indicated in FIG. 5.

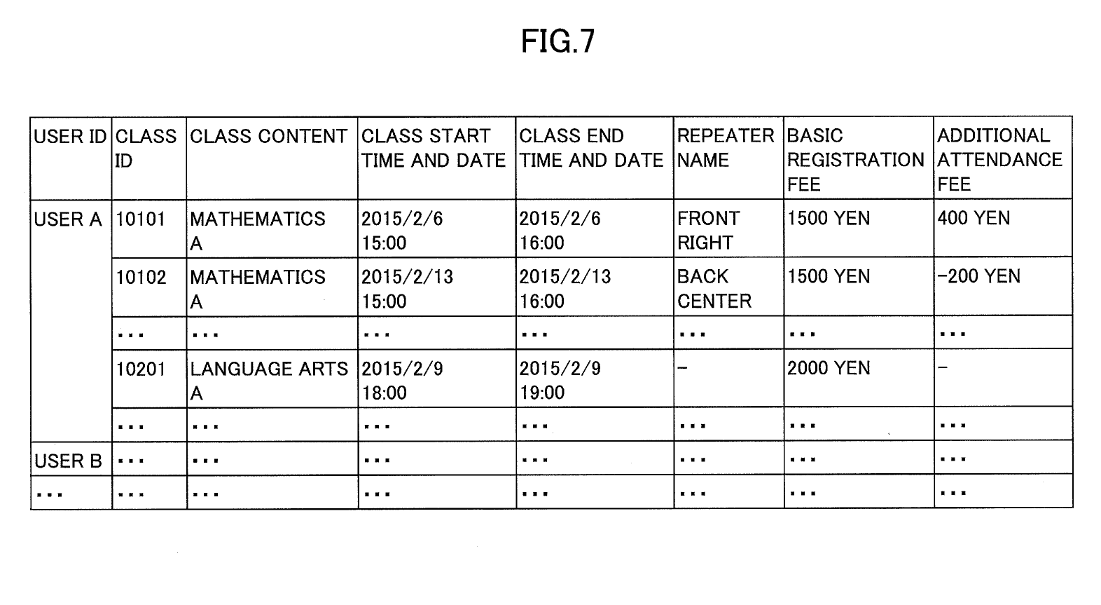

FIG. 7 illustrates an example of charging information. The charging information management unit 55 manages the basic registration fee and the additional attendance fee for each user ID and each class ID, as illustrated in FIG. 7.

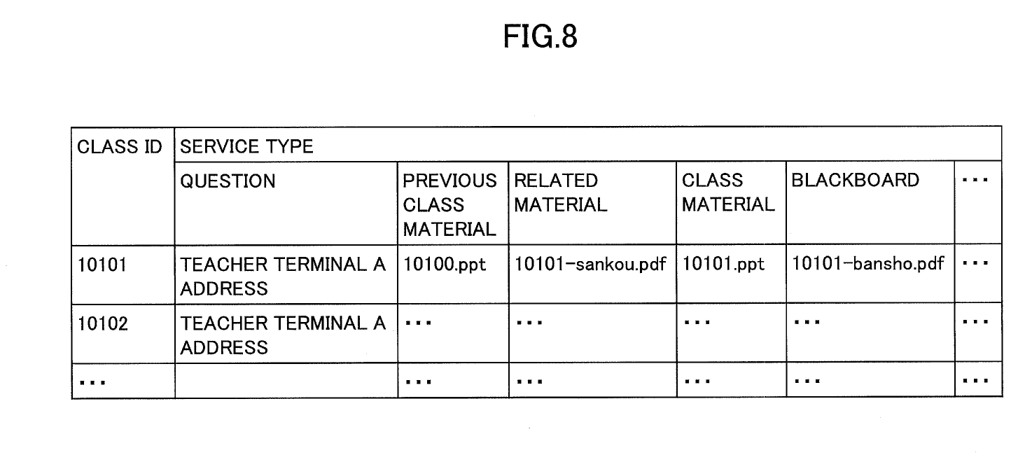

FIG. 8 illustrates an example of contents information. The service information storage unit 56 stores files of electronic data according to the service type for each class ID, such as the previous class material, related material, class material, etc., as illustrated in FIG. 8.

The transmitting/receiving unit 57 performs communication with the terminal 2 and the repeater 3 via the transmission network 6.

The service management unit 58 restricts the service to be provided based on a repeater ID, etc., of a repeater to which the terminal 2 has made a connection by short range radio communication, when a request to provide a service is received from the terminal 2.

The charging management unit 59 manages information relevant to charging for each user, based on the ID, etc., of the repeater 3 used by the user when the user attended the class.

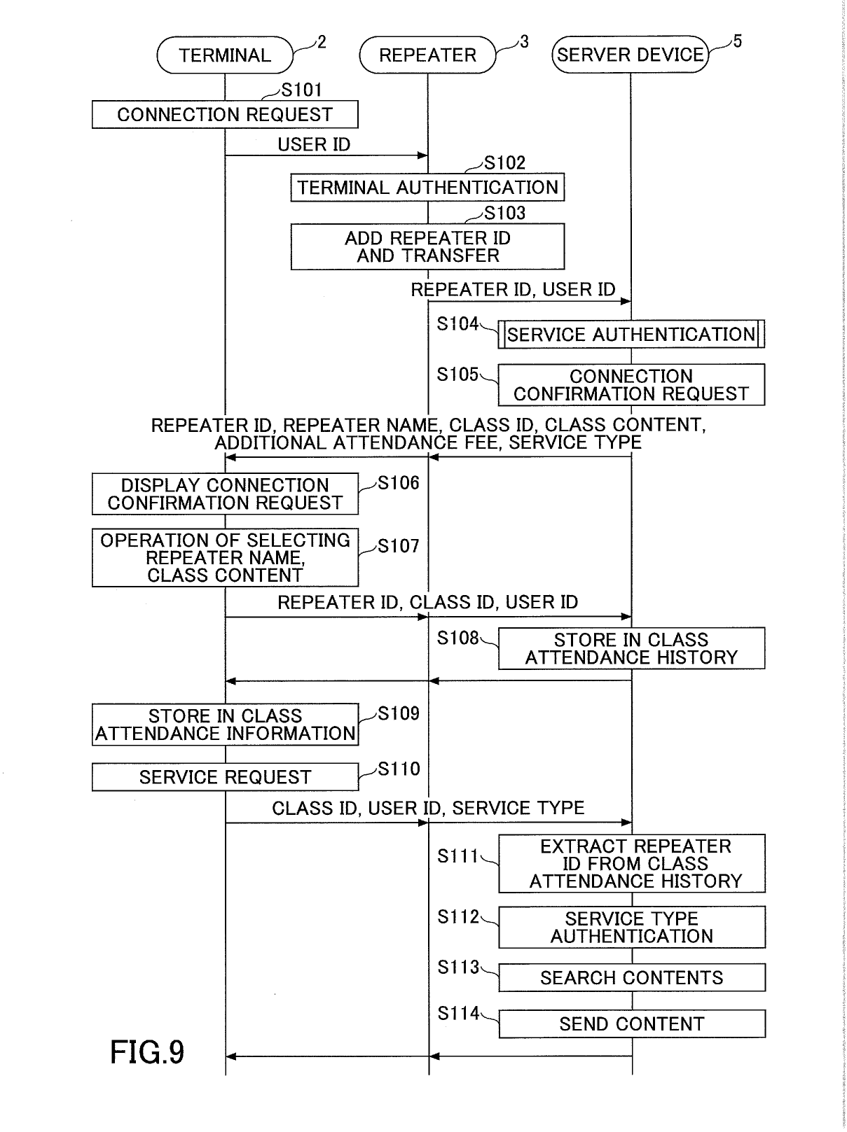

FIG. 9 is a sequence diagram of the service providing system 1 according to the first embodiment.

First, the terminal 2 sends, to the repeater 3, a connection request including a user ID stored in the user ID storage unit 23 (step S101). The connection authentication unit 33 of the repeater 3 authenticates the terminal 2 (step S102). Then, when the authentication is successful, the relay unit 32 adds, to the received connection request, a repeater ID stored in the repeater ID storage unit 34, and transfers the connection request to the server device 5 (step S103).

The service management unit 58 of the server device 5 performs the service authentication process described below, based on the user ID and the repeater ID included in the received connection request (step S104). Then, the server device 5 sends a connection confirmation request to the terminal 2 via the repeater 3. The connection confirmation request includes a repeater ID and a repeater name corresponding to the repeater ID, a class ID extracted by the service authentication process and the class content corresponding to the class ID, the additional attendance fee and the service type corresponding to the class ID and the repeater ID (step S105).

The terminal 2 displays, to the user of the terminal 2, the repeater name, the class content, the additional attendance fee, and the service type included in one or more connection confirmation requests that have been received (step S106). Then, when the user selects the repeater name and the class content of the class to be attended from one or more repeater names and class contents, by inputting the selection from the operation unit 25, the terminal 2 sends a class attendance request to the server device 5. The class attendance request includes a repeater ID and a class ID corresponding to the selected repeater name and class content, and the user ID stored in the user ID storage unit 23 (step S107). Accordingly, even when radio waves of short range radio communication are received form a plurality of repeaters at the same time, the user can use the desired repeater.

The charging management unit 59 of the server device 5 stores the class ID, the user ID, and the repeater ID included in the received class attendance request, in the class attendance history of FIG. 6, by the class attendance history management unit 54. Then, the charging management unit 59 searches the service information of FIG. 5 by using the class ID as the search key, to extract the information of the additional attendance fee and the service type. Furthermore, the charging management unit 59 searches the class information of FIG. 3 by using the class ID as the search key, to extract the class content, the class start time and date, the class end time and date, and the basic registration fee corresponding to the class ID. Furthermore, the charging management unit 59 searches the service information of FIG. 5 based on the class ID and the repeater ID, to extract the additional attendance fee corresponding to the class ID and the repeater ID. Then, the charging management unit 59 stores the class ID, the class content, the class start time and date, the class end time and date, the repeater name, the basic registration fee, and the additional attendance fee, in the charging information of FIG. 7 in association with the user ID, and returns a response to the terminal 2 (step S108).

When the terminal 2 receives the response, the terminal 2 stores, in the class attendance information storage unit 26, the repeater ID, the repeater name, the class ID, the class content, and the service type, corresponding to the selected repeater name and class content (step S109).

When the user of the terminal 2 makes a service request operation specifying the class content and the service type, the terminal 2 sends a service request including a class ID, a user ID, and a service type, to the server device 5 (step S110).

The service management unit 58 of the server device 5 searches the class attendance history of FIG. 6 based on the class ID and the user ID included in the received service request, and extracts a repeater ID corresponding to the class ID and the user ID (step S111). Then, the service management unit 58 searches the service information of FIG. 5 based on the class ID and the extracted repeater ID, and confirms whether the received service type is registered (step S112). Then, when the received service type is not registered, the service management unit 58 reports this to the terminal 2, and when the received service type is registered, the service management unit 58 searches the contents information of FIG. 8 based on the class ID and the service type included in the received service request (step S113), distributes the search-found content to the terminal 2, and causes the terminal 2 to display the content. When “question” is specified as the service type, the service management unit 58 transfers a question message for the teacher received from the terminal 2, to the address of the terminal used by the teacher, and causes the teacher's terminal to display the question message (step S114).

Note that the address of the server device 5 used for communication is included in the connection confirmation request sent from the server device 5 to the terminal 2 in step S105. Alternatively, the address of the server device 5 used for communication may be registered in the terminal 2, and the communication between the terminal 2 and the server device 5 from step S107 and onwards may be performed directly via the transmission network 6 without bypassing the repeater 3.

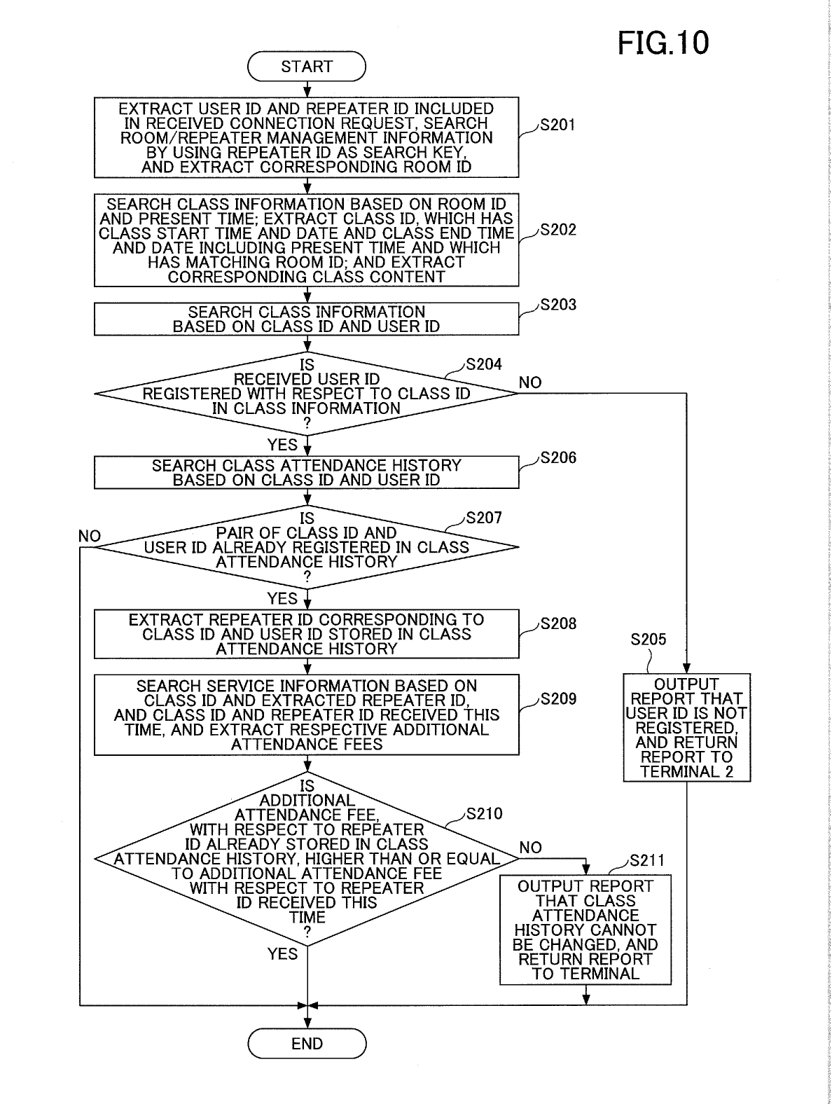

FIG. 10 is a flowchart of a service authentication process of step S104 in FIG. 9.

The service management unit 58 of the server device 5 extracts the user ID and the repeater ID included in the received connection request, searches the room/repeater information management information of FIG. 4 by using the repeater ID as a search key, and extracts a corresponding room ID (step S201). Then, the service management unit 58 searches the class information of FIG. 3 based on the room ID and the present time; extracts a class ID, which corresponds to a class start time and date and a class end time and date including the present time, and which corresponds to a matching room ID; and also extracts the class content corresponding to the class ID (step S202). Then, the service management unit 58 searches the class information of FIG. 3 based on the extracted class ID and the received user ID (step S203), and determines whether the received user ID is registered with respect to the class ID (step S204). When the user ID is not registered (NO in step S204), the service management unit 58 outputs a report that the user ID is not registered, and returns this report to the terminal 2 (step S205). When the user ID is registered (YES in step S204), the service management unit 58 searches the class attendance history of FIG. 6 based on the class ID and the user ID (step S206), and determines whether a pair of the class ID and the user ID is already registered (step S207). When the pair is not registered (NO in step S207), the service management unit 58 executes the processes of step S212 and onward described below.

On the other hand, when the pair is registered (YES in step S207), the service management unit 58 extracts the repeater ID corresponding to the class ID and the user ID stored in the class attendance history of FIG. 6 (step S208). The service management unit 58 searches the service information of FIG. 5 based on the class ID and the extracted repeater ID, and the class ID and the repeater ID received this time, and extracts the respective additional attendance fees (step S209). Then, the service management unit 58 determines whether the additional attendance fee, with respect to the repeater ID already stored in the class attendance history, is higher than or equal to the additional attendance fee with respect to the repeater ID received this time (step S210), and when the additional attendance fee, with respect to the repeater ID already stored in the class attendance history, is not higher than or equal to the additional attendance fee with respect to the repeater ID received this time (NO in step S210), the service management unit 58 outputs a report that the class attendance history cannot be changed, and returns the report to the terminal 2 (step S211). Accordingly, for example, after receiving the provision of a service, it is possible to reject to register a repeater ID having a cheaper attendance fee in the class attendance history. On the other hand, when the additional attendance fee, with respect to the repeater ID already stored in the class attendance history, is higher than or equal to the additional attendance fee with respect to the repeater ID received this time (YES in step S210), the process is ended.

Note that when the range in which the repeater 3 can perform short range radio communication is narrow, and short range radio communication is performed between the terminal 2 and the repeater 3 by holding the terminal 2 over the repeater 3, there is a low possibility that the terminal 2 is erroneously connected with another repeater 3. Therefore, in this case, steps S106 and S107 described above are omitted, and in step S108, the class ID, the user ID, and the repeater ID may be stored in the class attendance history of FIG. 6 by the class attendance history management unit 54, without receiving a class attendance request from the terminal 2. Accordingly, the user of the terminal 2 is saved of the trouble of making a selection operation.

Furthermore, in step S103, instead of having the repeater 3 attach a repeater ID to the connection request and transfer the connection request to the server device 5, the repeater 3 may report the repeater ID to the terminal 2, and the terminal 2 may send the connection request, to which the repeater ID is attached, to the server device 5 via the transmission network 6.

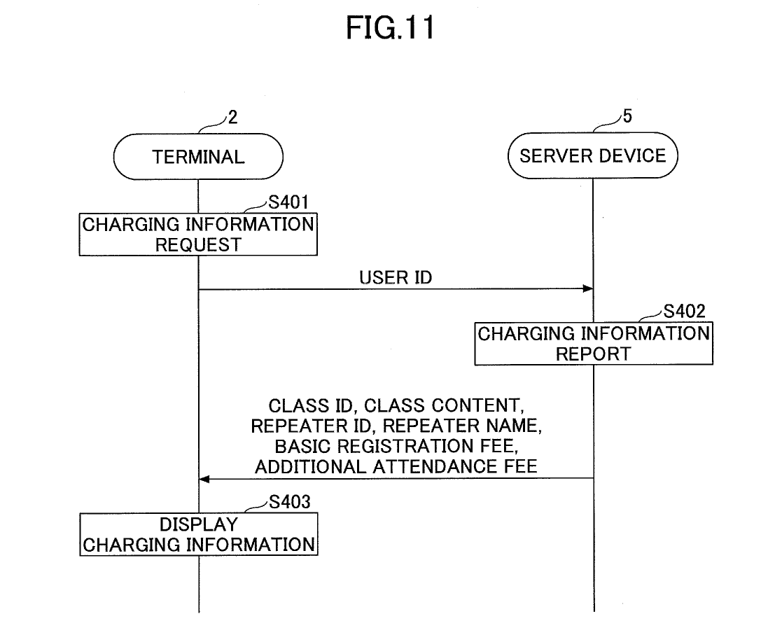

FIG. 11 is a sequence diagram of a process of reporting charging information.

When the terminal 2 receives, from the user of the terminal 2, an operation of requesting a report of charging information, the terminal 2 sends a charging information request including the user ID stored in the user ID storage unit 23, to the server device 5 (step S401). The charging management unit 59 of the server device 5 uses the user ID as the search key to search the charging information of FIG. 7, and returns, to the terminal 2, charging information including a class ID, a class content, a class start time and date, a class end time and date, a repeater name, a basic registration fee, and an basic registration fee, corresponding to the user ID (step S402). The terminal 2 displays the received charging information to the user (step S403).

According to the present embodiment, even without performing registration in advance, it is possible to automatically provide a service and charge a fee according to the position of the seat, etc., where the user sat in a class, etc., that the user attended.

### Second Embodiment

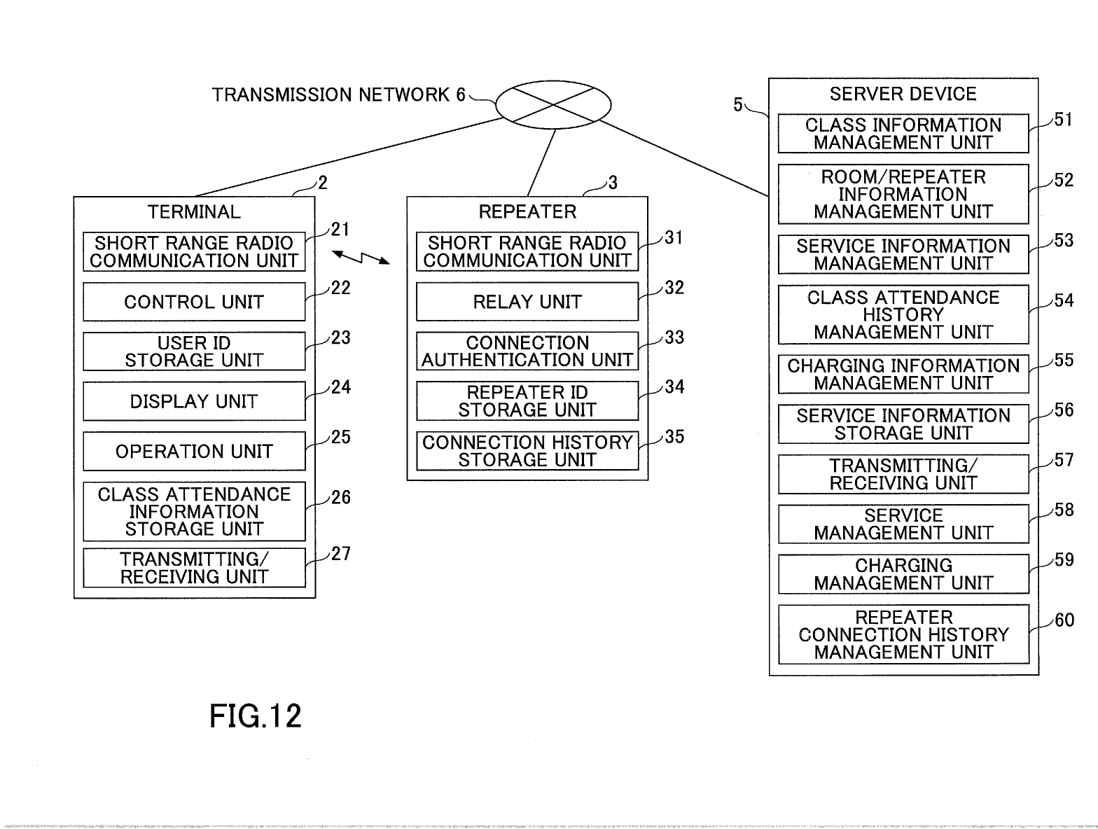

FIG. 12 is a configuration diagram of the service providing system 1 according to the second embodiment.

The second embodiment includes a function of charging a fee according to the time length of attending a class, in addition to the functions of the first embodiment.

The second embodiment includes the following elements, in addition to the elements of the first embodiment.

The repeater 3 further includes a connection history storage unit 35.

The connection history storage unit 35 detects the connection and the disconnection of short range radio communication with the terminal 2, and stores a user ID, a connection start time and date, and a connection end time and date.

The server device 5 further includes a repeater connection history management unit 60.

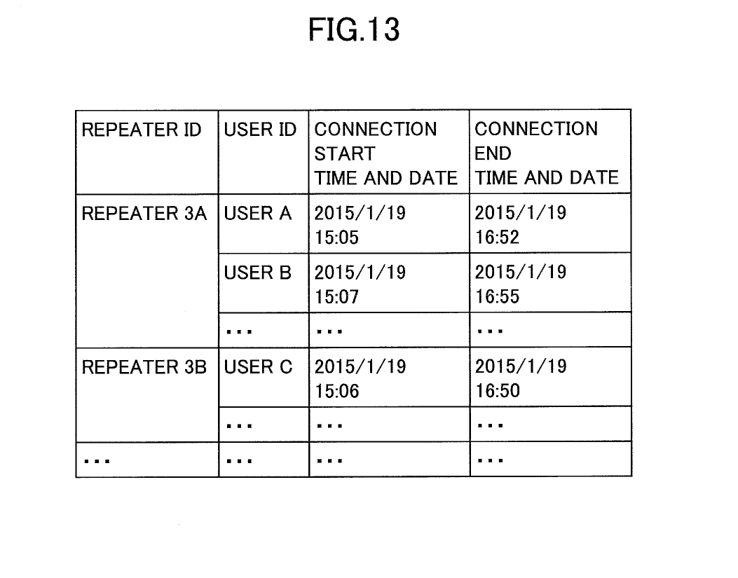

FIG. 13 illustrates an example of connection history, which is the history of connections made from the terminal 2 to the repeater 3. The repeater connection history management unit 60 stores connection history including a repeater ID, a user ID, a connection start time and date, and a connection end time and date, illustrated in FIG. 13. The repeater connection history management unit 60 acquires, from the connection history storage unit 35 of each repeater 3, the connection history illustrated in FIG. 13 that is the history of connections made from the terminal 2 to each repeater 3. The repeater connection history management unit 60 acquires and stores the connection history periodically, or every time a new history item is generated.

The charging management unit 59 of the server device 5 calculates the amount of fee to be charged based on the time length of attending a class. For example, the charging management unit 59 searches the charging information of FIG. 7 based on the user ID, the connection start time and date, and the connection end time and date extracted from the connection history of FIG. 13. The charging management unit 59 and extracts a data item from the charging information in FIG. 7, which corresponds to a matching user ID, and which corresponds to a class start time and date and a class end time and date including at least part of a time length between the connection start time and date and the connection end time and date in the connection history of FIG. 13. Then, the charging management unit 59 calculates a class attendance ratio, by dividing the time length between the connection start time and date and the connection end time and date in the connection history of FIG. 13, by the time length between the class start time and date and the class end time and date of the charging information in FIG. 7. When the class attendance ratio exceeds one, the class attendance ratio is set as one, and the attendance fee to be charged is obtained by multiplying the basic registration fee in the charging information of FIG. 7 by the class attendance ratio, and adding the additional attendance fee of FIG. 7 to the result of multiplication.

Furthermore, the attendance fee to be charged may be obtained by multiplying the basic registration fee by an inverse number of the class attendance ratio, and adding the additional attendance fee of FIG. 7 to the result of multiplication. Accordingly, the amount of fee to be charged decreases as the class attendance ratio increases, and therefore an incentive is given to the user for increasing the class attendance ratio.

### Third Embodiment

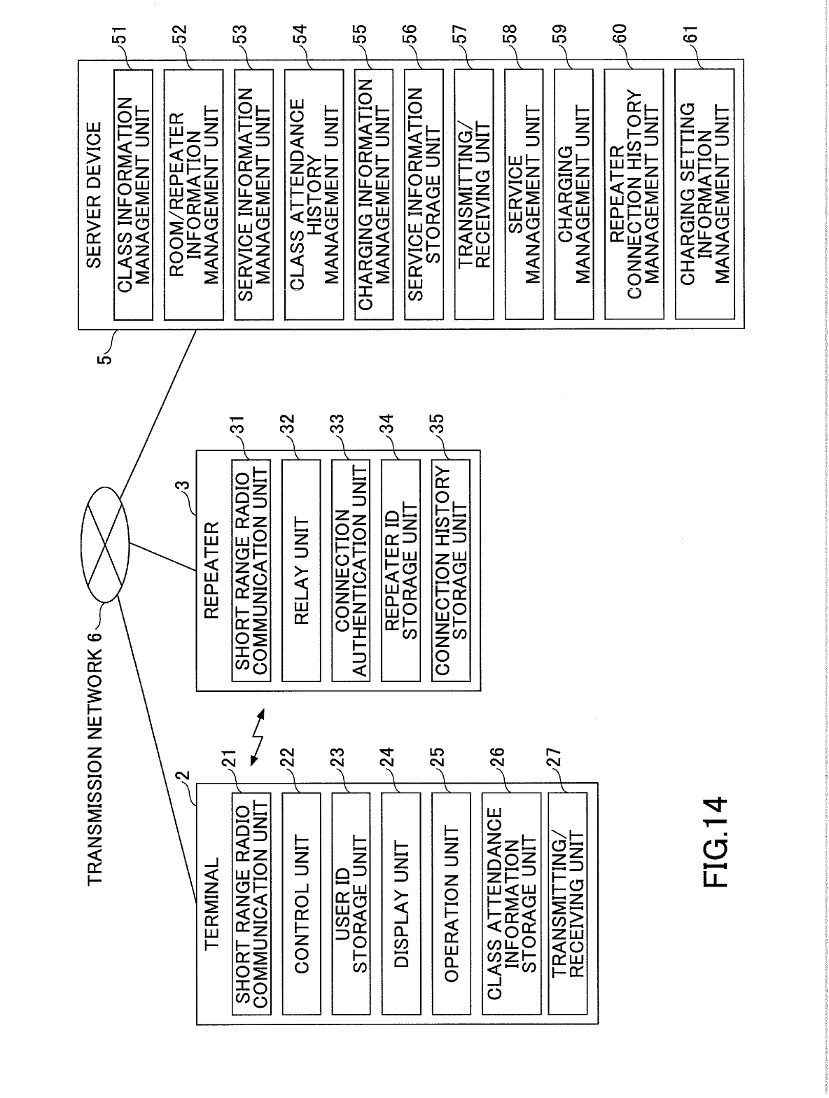

FIG. 14 is a configuration diagram of the service providing system 1 according to a third embodiment.

The third embodiment includes a function of charging a fee based on the performance of a test relevant to the class and the repeater ID in the class attendance history, in addition to the functions of the first or second embodiment.

The third embodiment includes the following elements, in addition to the elements of the first or second embodiment.

The server device 5 further includes a charging setting information management unit 61.

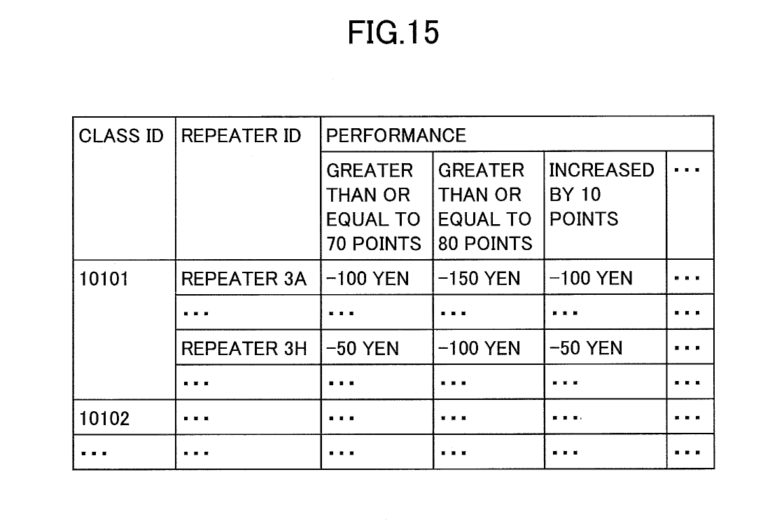

FIG. 15 illustrates an example of charging setting information. The charging setting information management unit 61 stores the charging setting information illustrated in FIG. 15, including a class ID, a repeater ID, and an amount of the charged fee for each of the conditions relevant to the performance.

The charging management unit 59 of the server device 5 manages information of scores corresponding to a class for each user, and charges a fee according to the score of the test and the increase or decrease of the score compared to that of the previous test. For example, the charging management unit 59 calculates the fee to be charged by adding a fee according to the charging setting information of FIG. 15, to the basic registration fee and the additional attendance fee in the charging information of FIG. 7. Accordingly, for example, when a high fee is charged when the academic achievement increases for a user who sat at a seat at the front when attending the class, the incentive increases for the person giving the class. On the other hand, when a low fee is charged when the academic achievement increases for a user who sat at a seat at the front when attending the class, the incentive increases for the user attending the class.

### Modification Example

Note that the charging management unit 59 may charge an additional fee according to the type of service used at the terminal 2. Furthermore, the charging management unit 59 may charge an additional fee according to the data amount of the content of the service downloaded to the terminal 2. Accordingly, when the user of the terminal 2 sits down at predetermined seat, connects to a predetermined repeater 3, and becomes capable of receiving the provision of a service that the user does not desire, the fee can be charged according to the service that the user has actually used.

Furthermore, when a connection request is received from the terminal 2, in step S204 of FIG. 10, even when the user ID of the terminal 2 is not registered with respect to the class ID in the class information of FIG. 3, the user may be able to receive the provision of a limited service, for example, such as being able to download at least the class material.

Furthermore, the server device 5 may be formed of a plurality of servers, and each of the servers may be provided with any of the functions. For example, a server device 5A may be a service providing server including the service information storage unit 56, a server device 5B may be a charging server including the charging information management unit 55 and the charging management unit 59, and the server device 5C may be a system management server including the functions other than the above. The server device 5C, which is the system management server, may receive requests from the terminal 2, the server device 5C may instruct the server device 5A, which is the service providing server, to provide a service to the terminal 2, and the server device 5C may report information necessary for charging, to the server device 5B which is the charging server.

Note that, in the above embodiments, the configuration of the system to which the terminal 2, the repeater 3, and the server device 5 are connected is one example; there may be various examples of system configurations according to the purpose and the objective.

### <Hardware Configuration>

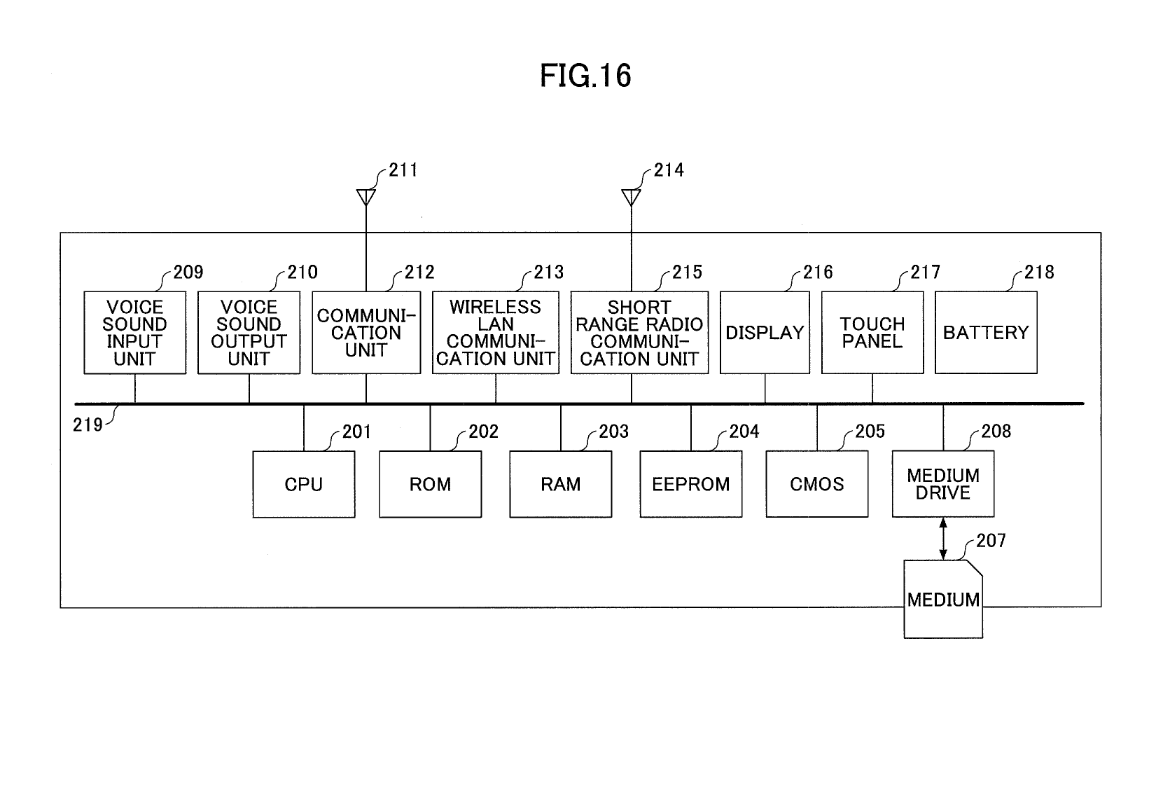

The terminal 2 is realized by a hardware configuration illustrated in FIG. 16, for example. FIG. 16 is a hardware configuration diagram of an example of a terminal according to the present embodiment. The terminal 2 in FIG. 16 includes a CPU 201, a ROM 202, a RAM 203, an EEPROM 204, a CMOS sensor 205, and a medium drive 208.

The CPU 201 controls the operations of the entire terminal 2. The ROM 202 stores a basic input output program. The RAM 203 is used as a work area of the CPU 201. The EEPROM 204 performs reading or writing of data according to control by the CPU 201. The CMOS sensor 205 obtains image data by capturing an object according to control by the CPU 201.

The medium drive 208 controls the reading or writing (storing) of data with respect to a recording medium 207 such as a flash memory. Data already recorded in the recording medium 207 can be read from the recording medium 207, or new data can be written and stored in the recording medium 207. The recording medium 207 is detachably attached to the medium drive 208.

Note that the EEPROM 204 stores association information required for the OS executed by the CPU 201, network settings, etc. The applications for executing various processes according to an embodiment of the present invention are stored in the EEPROM 204 or in the recording medium 207.

Furthermore, the CMOS sensor 205 is a charge-coupled device for computerizing an image of an object, by converting light into electric charges. The CMOS sensor 205 may be, for example, a CCD (charge-coupled device) sensor, as long as an object can be captured.

Furthermore, the terminal 2 includes a voice sound input unit 209, a voice sound output unit 210, an antenna 211, a communication unit 212, a wireless LAN communication unit 213, an antenna 214 short range radio communication, a short range radio communication unit 215, a display 216, a touch panel 217, and a bus line 219.

The voice sound input unit 209 converts voice sound into voice sound signals. The voice sound output unit 210 converts voice sound signals into voice sound. The communication unit 212 uses the antenna 211 to perform communication with the nearest base station device by radio communication signals. The wireless LAN communication unit 213 performs wireless LAN communication complying with the IEEE80411 standard, with an access point. The short range radio communication unit 215 performs short range radio communication by using the antenna 214 for short range radio communication.

The display 216 is a liquid crystal or organic EL, etc., for displaying an image of an object, various icons, etc. The touch panel 217 is mounted on the display 216, and is formed of a pressure-sensitive or electrostatic panel, and detects a touched position on the display 216 by receiving a touch from a fingertip, a touch pen, etc. The bus line 219 is an address bus, a data bus, etc., for electrically connecting the above units.

Furthermore, the terminal 2 is provided with an exclusive-use battery 218. The terminal 2 is driven by the battery 218. Note that the voice sound input unit 209 includes a microphone for inputting voice sound. The voice sound output unit 210 includes a speaker for outputting voice sound.

As described above, the terminal 2 according to the present embodiment can realize various processes as described above, by the above-described hardware configuration.

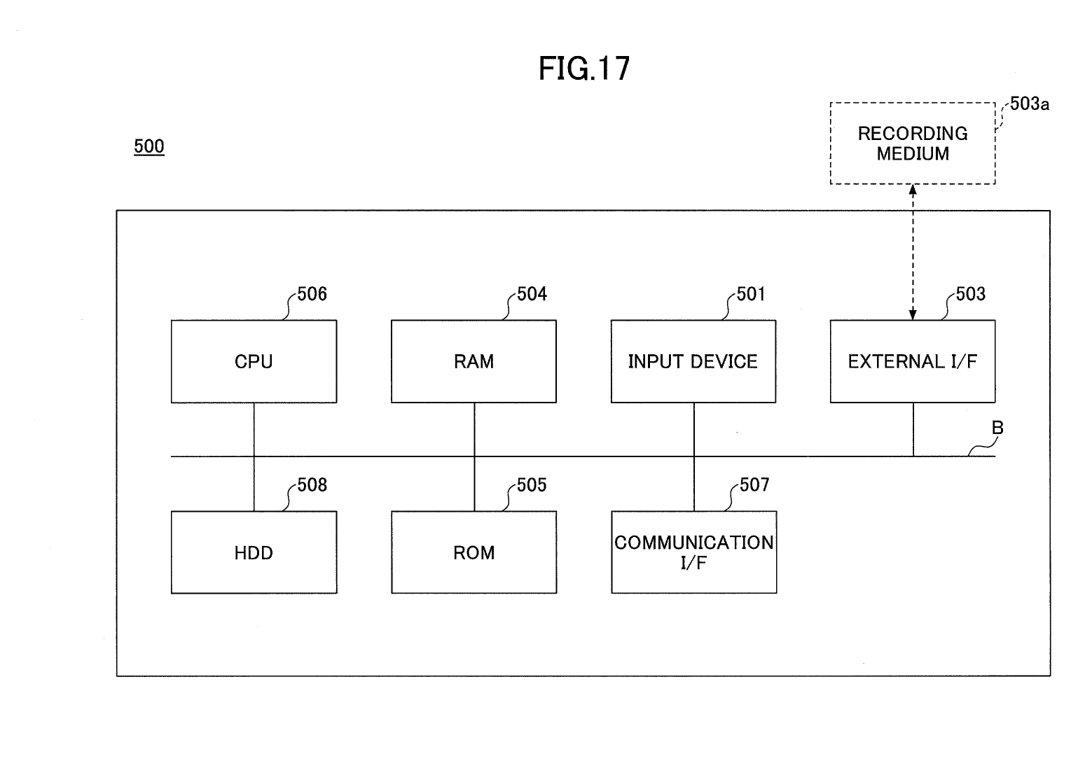

The server device 5 is realized by a computer system having a hardware configuration as illustrated in FIG. 17, for example. FIG. 17 is a hardware configuration diagram of an example of a computer system according to the present embodiment.

A computer system 500 illustrated in FIG. 17 includes an input device 501, an external I/F 503, a RAM 504, a ROM 505, a CPU 506, a communication I/F 507, a HDD 508, etc., which are interconnected by a bus B. The input device 501 includes a keyboard and a mouse, and is used for inputting various operation signals in the computer system 500.

The HDD 508 is a non-volatile storage device storing programs and data. The stored programs and data include an OS (Operating System), which is the basic software for controlling the entire computer system 500, application programs for providing various functions in the OS, etc. The HDD 508 manages the stored programs and data by a predetermined file system and/or a DB (database).

The external I/F 503 is an interface between the computer system 500 and an external device. An example of an external device is a recording medium 503a. Accordingly, the computer system 500 can perform reading of and/or writing in the recording medium 503a, via the external I/F 503. Examples of the recording medium 503a are a flexible disk, a CD, a DVD (Digital Versatile Disk), an SD memory card, a USB (Universal Serial Bus) memory, etc.

The ROM 505 is a non-volatile semiconductor memory (storage device) that can hold programs and data even after the power is turned off. The ROM 505 stores programs and data such as a BIOS (Basic Input/Output System) that is executed when the computer system 500 is started up, OS settings, network settings, etc. The RAM 504 is a volatile semiconductor memory (storage device) that can temporarily hold programs and data.

The CPU 506 is an arithmetic device for loading programs and data from storage devices such as the ROM 505 and the HDD 508, into the RAM 504, and executing processes, to control the entire computer system 500 and realize functions.

In the computer system 500 according to the present embodiment, various programs described above can be realized by cooperation of hardware resources and programs, according to combinations of the above hardware resources, programs, and data.

According to one embodiment of the present invention, a service providing system is provided, which is capable of providing a service and charging a fee for a service according to the position of the seat, etc., in a class, etc., that the user has attended.

The service providing system, the server device, and the service providing method are not limited to the specific embodiments described herein, and variations and modifications may be made without departing from the spirit and scope of the present invention.

The present application is based on and claims the benefit of priority of Japanese Priority Patent Application No. 2015-049942, filed on Mar. 12, 2015, the entire contents of which are hereby incorporated herein by reference.

What is claimed is:

1. A service providing system comprising:
a terminal;
a repeater; and
a server device, wherein
the terminal includes
a terminal short range radio communication unit configured to perform short range radio communication with the repeater, and
a terminal transmitting unit configured to send a connection request including a user ID for identifying a user of the terminal, to the server device, and wherein
the server device includes
a receiving unit configured to receive a connection request including a repeater ID for identifying the repeater and the user ID, from the terminal or the repeater, and
a service management unit configured to manage a type of a service that can be provided to the user, based on the received repeater ID and user ID.

2. The service providing system according to claim 1, wherein
a plurality of the repeaters are disposed in an area where a same event is held, and
the service management unit identifies the event, based on a present time when the repeater ID is received, and manages the type of the service relating to the event that can be provided to the user, based on the repeater ID and the event.

3. The service providing system according to claim 2, wherein
in a case where the user ID is already stored in association with a second repeater ID when the connection request including a first repeater ID and the user ID is received in the same event, the service management unit determines whether to update the repeater ID stored in association with the user ID based on the first repeater ID and the second repeater ID.

4. The service providing system according to claim 1, wherein
the terminal includes
a terminal receiving unit configured to receive a plurality of the repeater IDs, and
an operation unit by which the user can select the repeater ID to be sent to the server device, from among the received plurality of the repeater IDs.

5. The service providing system according to claim 1, wherein
the server device includes a charging management unit configured to determine an amount of a fee to be charged to the user, based on the repeater ID.

6. The service providing system according to claim 2, wherein
the server device includes a charging management unit configured to determine an amount of a fee to be charged to the user, based on the repeater ID and information relating to the user that has changed according to the same event.

7. The service providing system according to claim 5, wherein
the charging management unit determines the amount of the fee to be charged to the user, based on the type of the service or a data amount of the service used according to the user ID.

8. The service providing system according to claim 5, wherein
the charging management unit determines the amount of the fee to be charged to the user, based on a length of a time during which the repeater and the terminal are connected by the short range radio communication.

9. The service providing system according to claim 1, wherein
the service management unit manages a content that can be downloaded from the terminal, as the type of the service.

10. The service providing system according to claim 1, wherein
the service management unit manages permission/rejection of transmission of a message from the terminal to a predetermined device, as the type of the service.

11. A server device comprising:
a receiving unit configured to receive a connection request, the connection request including a user ID for identifying a user of a terminal and a repeater ID that is information for identifying a repeater that performs short range radio communication with the terminal; and
a service management unit configured to manage a type of a service that can be provided to the user, based on the received repeater ID and user ID.

12. The server device according to claim 11, wherein
a plurality of the repeaters are disposed in an area where a same event is held,
the service management unit identifies the event, based on a present time when the repeater ID is received, and manages the type of the service relating to the event that can be provided to the user, based on the repeater ID and the event, and
in a case where the user ID is already stored in association with a second repeater ID when the connection request including a first repeater ID and the user ID is received in the same event, the service management unit determines whether to update the repeater ID stored in association with the user ID based on the first repeater ID and the second repeater ID.

13. The server device according to claim 11, wherein
the server device includes a charging management unit configured to determine an amount of a fee to be charged to the user, based on the repeater ID.

14. The server device according to claim 11, wherein
a plurality of the repeaters are disposed in an area where a same event is held,
the service management unit identifies the event, based on a present time when the repeater ID is received, and manages the type of the service relating to the event that can be provided to the user, based on the repeater ID and the event, and
the server device includes a charging management unit configured to determine an amount of a fee to be charged to the user, based on the repeater ID and information relating to the user that has changed according to the same event.

15. The server device according to claim 13, wherein
the charging management unit determines the amount of the fee to be charged to the user, based on the type of the service or a data amount of the service used according to the user ID.

16. The server device according to claim 13, wherein
the charging management unit determines the amount of the fee to be charged to the user, based on a length of a time during which the repeater and the terminal are connected by the short range radio communication.

17. The server device according to claim 11, wherein
the service management unit manages a content that can be downloaded from the terminal, as the type of the service.

18. The server device according to claim 11, wherein
the service management unit manages permission/rejection of transmission of a message from the terminal to a predetermined device, as the type of the service.

19. A service providing method executed by a server device, the service providing method comprising:
receiving a connection request, the connection request including a user ID for identifying a user of a terminal and a repeater ID that is information for identifying a repeater that performs short range radio communication with the terminal; and
managing a type of a service that can be provided to the user, based on the received repeater ID and user ID.
